(19) United States
(12) Patent Application Publication
(10) Pub. No.: US 2002/0155285 A1
(43) Pub. Date: Oct. 24, 2002

(54) Bio-wave card and sticky piece

(76) Inventor: Ren-Sheng Ou, Taipei (TW)

Correspondence Address: DOUGHERTY & TROXELL, Suite 1404, 5205 LEESBURG PIKE, FALLS CHURCH, VA, 22041, US

(21) Appl. No.: 09/841,118

(22) Filed: Apr. 24, 2001

(51) Int. Cl. B32B 7/12

(52) U.S. Cl. 428/352; 428/343

(57) ABSTRACT

A bio-wave card or sticky piece is disclosed. Powdered or liquid micro elements containing Ca, Ti, Cr, Co, Ni, Cu, Pb, Cl, Mn, Fe, Zn, etc. are adhered to a hard card through laser technology so as to be formed with a thin layer with a preset shape, or are distributed to the surfaces of a plurality of soft sticky piece through laser technology. Another, bio-wave card and sticky piece are combined as an integral body; a plurality of bio-wave soft sticky piece are pre-adhered to the back sides of the hard card so that it can be carried easily; the soft sticky piece is torn away as desired. By the hard card or the soft sticky piece, as a multiple bio-waves are overlapped with the natural frequencies of the cell in the organs of the human body, oscillation absorbing frequencies will generate so as to have the effect of increasing the immunity of human body.

### FIELD OF THE INVENTION

The present invention relates to a bio-wave card or sticky piece. Powdered or liquid micro elements containing Ca, Ti, Cr, Co, Ni, Cu, Pb, Cl, Mn, Fe, Zn, etc. are adhered to a hard card through laser technology so as to be formed with a thin layer with a preset shape, or is distributed to the surfaces of a plurality of soft sticky piece through laser technology. bio-wave card and sticky piece are combined as an integral body; a plurality of bio-wave soft sticky piece are pre-adhered to the back sides of the hard card so that it can be carried easily; the soft sticky piece is torn away as desired. By the hard card or the soft sticky piece, as a multiple bio-waves are overlapped with the natural frequencies of the cell in the organs of the human body, oscillation absorbing frequencies will generate so as to have the effect of increasing the immunity of human body.

### BACKGROUND OF THE INVENTION

According to medial research, human skins are a complex neuron transmission unit, which are distributed uniformly in the whole body as a message transmitter and a message decoder. The brain is a bio-electronic network. By transmitting message, it can be converted into energy of any form. The energy of the bio-wave can be amplified by the electronic equipment to be as signals for being used in research. This has identical effect as Chi-Kung in the conventional Chinese medicine. The known health products about the bio-wave comprises tight underwear, eye masks, skin protecting glue, etc.

### SUMMARY OF THE INVENTION

Accordingly, the primary object of the present invention is to provide a bio-wave card or sticky piece. Powdered or liquid micro elements containing Ca, Ti, Cr, Co, Ni, Cu, Pb, Cl, Mn, Fe, Zn, etc. are adhered to a hard card through laser technology so as to be formed with a thin layer with a preset shape. Bio-wave card and sticky piece are combined as an integral body; a plurality of bio-wave soft sticky piece are pre-adhered to the back sides of the hard card so that it can be carried easily; the soft sticky piece is torn away as desired. By the hard card or the soft sticky piece, as a multiple bio-waves are overlapped with the natural frequencies of the cell in the organs of the human body, oscillation absorbing frequencies will generate so as to have the effect of increasing the immunity of human body. In using the bio-wave card of the present invention, a water (alcohol) cup is firstly located on the hard card 1 so that the bottom of the cup is in contact with the thin layer with micro elements. Then the alcohol is activated as fat or chlorine in water is decomposed for decreasing the harmful gas and water is activated. Besides, it may be used to decrease the nicotine and tar in cigarettes.

To achieve above objects, the present invention provides a bio-wave card or sticky piece, wherein micro elements are adhered to the thin layer of the card, while the configuration is not limited.

Another object of the present invention is to provide a bio-wave card or sticky piece, wherein the powdered or liquid micro elements containing Ca, Ti, Cr, Co, Ni, Cu, Pb, Cl, Mn, Fe, Zn, etc. are distributed to the surfaces of a plurality of soft sticky piece through laser technology. In using the bio-wave sticky piece of the present invention, a set of bio-wave sticky pieces of the present invention can be adhered to the ache portion of human body so that as the multiple bio-waves are overlapped with the natural frequencies of cells of the organs of the human body, an oscillation absorption effect is generated so as to increase the immunity of human body, the circulation of blood, and the effect of releasing human body.

The various objects and advantages of the present invention will be more readily understood from the following detailed description when read in conjunction with the appended drawing.

### BRIEF DESCRIPTION OF THE DRAWINGS

FIG. 1 shows the embodiment that the present invention is used to a hard card.

FIG. 2 shows the embodiment that the present invention is used to a soft sticky piece.

FIG. 3 shows a schematic view showing one embodiment that the thin film of the micro element is installed at the hard card.

FIG. 4 shows a schematic view showing another embodiment that the thin film of the micro element is installed at the hard card.

FIG. 5 shows a schematic view showing a further embodiment that the thin film of the micro element is installed at the hard card.

FIG. 6 shows an embodiment that the hard card and soft sticky piece of the present invention are combined together.

### DETAILED DESCRIPTION OF THE PREFERRED EMBODIMENTS

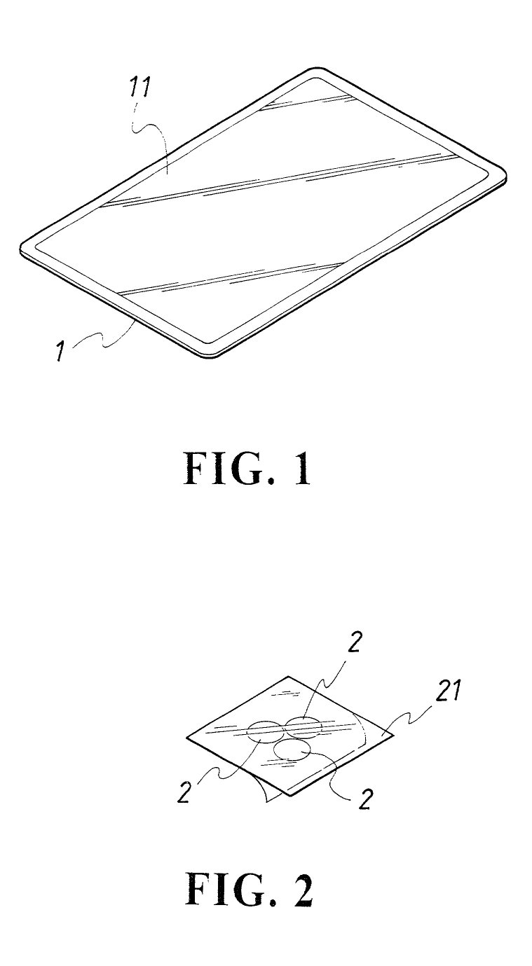

Referring to FIGS. 1 and 2, the bio-wave card or soft sticky piece of the present invention is illustrated. In the present invention, the powdered or liquid micro elements containing Ca, Ti, Cr, Co, Ni, Cu, Pb, Cl, Mn, Fe, Zn, etc. are adhered to a hard card 1 through laser technology so as to be formed with a thin layer 11 with a preset shape (referring to FIG. 1), or the powdered or liquid micro elements containing Ca, Ti, Cr, Co, Ni, Cu, Pb, Cl, Mn, Fe, Zn, etc. are distributed to the surfaces of a plurality of soft sticky piece 2 through laser technology. The soft sticky piece 2 is installed with a protecting film 21. In using, it can be torn away. By the hard card 1 or the soft sticky piece 2, as a multiple bio-waves are overlapped with the natural frequencies of the cell in the organs of the human body, oscillation absorbing frequencies will generate so as to have the effect of increasing the immunity of human body.

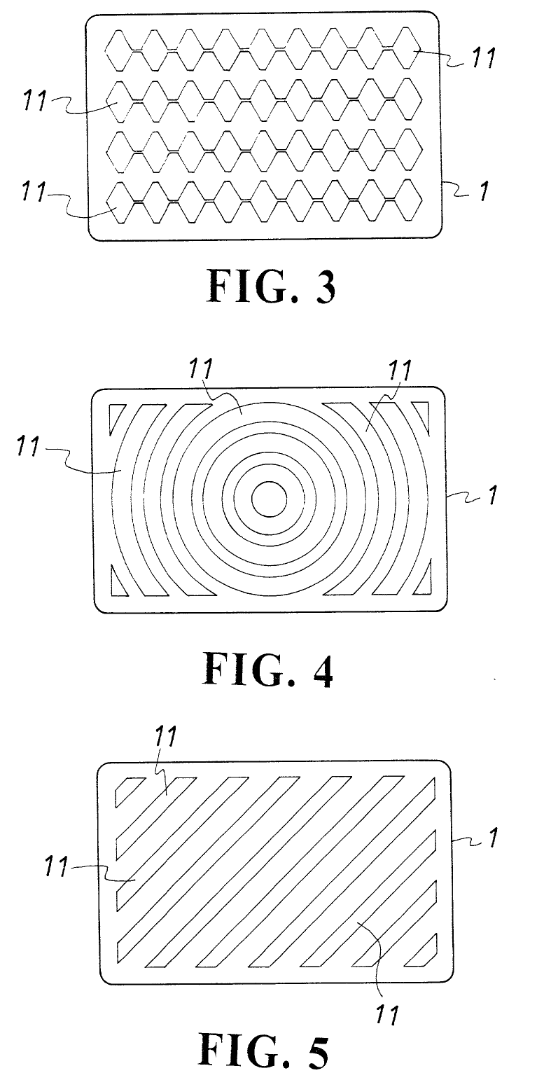

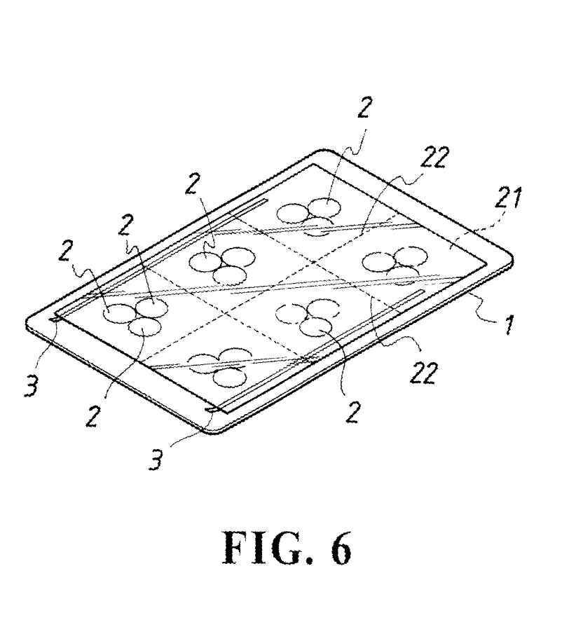

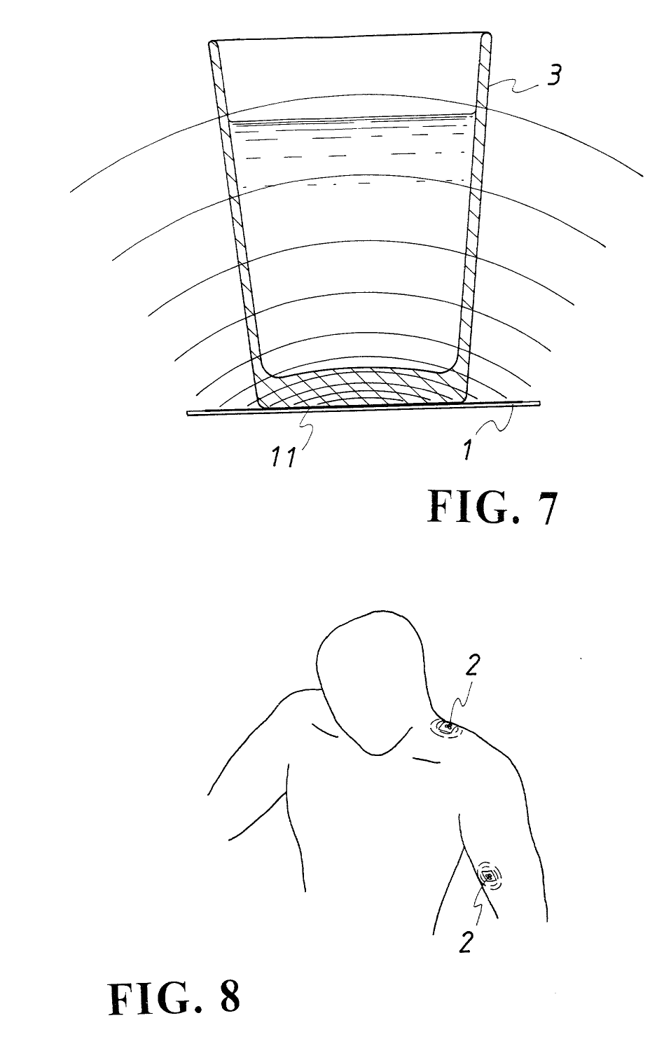

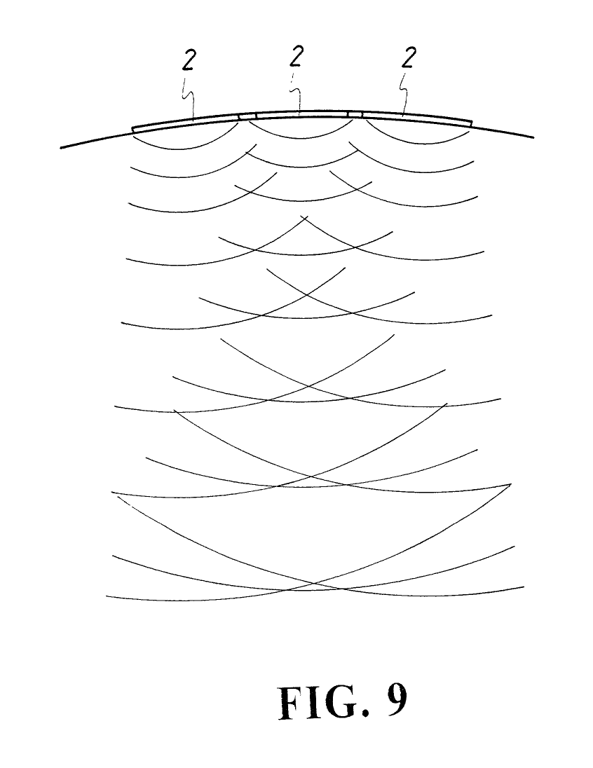

In the aforesaid bio-wave card, the distribution of the thin layer 11 by adhering the micro elements to the hard card 1 is not confined, it may be a rectangular shape (referring to FIG. 1) or a round shape, or distributed in several sections (referring to FIG. 3), or in a radiated pattern (referring to FIG. 4), or as multiple stripes (referring to FIG. 5), or other patterns or geometrical shapes (referring to FIG. 5). All these may serve in the present invention.

With reference to FIG. 5, the bio-wave card 1 and sticky piece 2 according to the present invention may be combined as an integral body. A plurality of bio-wave soft sticky piece 2 are pre-adhered to the back sides of the hard card 1 so that it can be carried easily. The soft sticky piece 2 can be torn away as desired. Another, a wire 3 (or a pulling piece) can be embedded between hard card 1 and soft sticky piece 2. Thereby the wire 3 may be pulled away firstly, so that the soft sticky piece 2 and hard card 1 can be separated rapidly. Thus, the soft sticky piece 2 can be torn away conveniently. Separable lines 22 may be formed in advance at the soft sticky piece 2 at the back side of the bio-wave card 1 so that the soft sticky piece 2 can be torn away one by one.

Referring to FIG. 7, in using the bio-wave card 1 of the present invention, a water (alcohol) cup 3 is firstly located on the hard card 1 so that the bottom of the cup is in contact with the thin layer 11 with micro elements. Then the alcohol is activated like fat or chlorine in water is decomposed for decreasing the harmful gas and water is activated. Besides, it may be used to decrease the nicotine and tar in cigarettes.

Referring to FIG. 8, in using the bio-wave sticky piece 2 of the present invention, a set of bio-wave sticky pieces 2 of the present invention can be adhered to the ache portion of human body so that as the multiple bio-waves are overlapped with the natural frequencies of cells of the organs of the human body, an oscillation absorption effect is generated (referring to FIG. 9) so as to increase the immunity of human body, the circulation of blood, and the effect of releasing human body.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bio-wave card, characterized in that: powdered or liquid micro elements containing Ca, Ti, Cr, Co, Ni, Cu, Pb, Cl, Mn, Fe, Zn, are adhered to a hard card through laser technology so as to be formed with a thin layer with a preset shape.

2. A bio-wave card sticky piece, characterized in that: powdered or liquid micro elements containing Ca, Ti, Cr, Co, Ni, Cu, Pb, Cl, Mn, Fe, Zn, are distributed to the surfaces of a plurality of soft sticky piece through laser technology; and the soft sticky piece is installed with a protecting film.

3. The bio-wave card as claimed in claim 1, wherein the micro elements are adhered to a thin layer formed by the hard card and with a preset shape, and the distribution is not confined.

4. The bio-wave card and a bio-wave sticky piece as claimed in claim 1 or 2, wherein bio-wave card and sticky piece are combined as an integral body; a plurality of bio-wave soft sticky piece are pre-adhered to the back sides of the hard card so that it can be carried easily; the soft sticky piece is torn away as desired.

5. The bio-wave card and a bio-wave sticky piece as claimed in claim 4, wherein a wire is embedded between hard card and soft sticky piece; thereby the wire is pulled away firstly, so that the soft sticky piece and hard card is separated rapidly.

6. The bio-wave card and a bio-wave sticky piece as claimed in claim 4, wherein separable lines are formed in advance at the soft sticky piece at the back side of the bio-wave card so that the soft sticky piece can be torn away one by one.
